(19) United States
(12) Patent Application Publication
(10) Pub. No.: US 2010/0108578 A1
(43) Pub. Date: May 6, 2010

(54) MEANS FOR THE SEPARATION OF MAGNETIC PARTICLES

(75) Inventors: Wendy Uyen Dittmer, Eindhoven (NL); Jeroen Hans Nieuwenhuis, Waalre (NL); Peggy De Kievit, Valkenswaard (NL); Kim Van Ommering, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,833

(22) PCT Filed: Jan. 31, 2008
(86) PCT No.: PCT/IB2008/050365

§ 371 Date: Aug. 5, 2009

(30) Foreign Application Priority Data
Feb. 7, 2007 (EP) 07101918.6

(51) Int. Cl. B03C 1/02

(52) U.S. Cl. 209/636

(57) ABSTRACT

The invention relates to an apparatus (300) and a method for the separation of magnetic particles (1, 2) according to their properties, particularly their magnetic susceptibility. The apparatus comprises a magnetic field generator (320) with which magnetic actuation forces (Fm) can be exerted on the magnetic particles (1, 2) that affect a prevailing movement of the particles (1, 2), said movement being caused by non-magnetic influences, e.g. thermal energy or viscous drag (Fh). The magnetic field generator may for example comprise: (i) a wire (321) that crosses the flow of a sample fluid with varying inclination (α); (ii) wires that generate a local minimum of a magnetic potential from which different particles escape by Brownian motion with different rates; or (iii) pairs of particle-attracting wires for which the attraction of one wire is temporarily interrupted to allow the fastest magnetic particles to escape.

The invention relates to an apparatus and a method for the separation of magnetic particles according to their physical properties, particularly their magnetic susceptibility. Moreover, it relates to the use of such an apparatus.

Microscopic magnetic particles are increasingly used in many chemical and biological procedures. The WO 2005/072855 A1 describes in this respect means for inducing a flow in a sample fluid by moving magnetic particles via a rotating external magnetic field in combination with a plurality of local magnetic elements fixed to the corresponding container. A separation of particles according to their physical properties is however not achieved.

Based on this situation it was an object of the present invention to provide means for separating magnetic particles, particularly particles with a diameter smaller than about 1 micrometer, according to their physical properties.

This object is achieved by an apparatus according to claim 1, a method according to claim 14, and a use according to claim 17. Preferred embodiments are disclosed in the dependent claims.

The apparatus according to the present invention serves (exclusively or inter alia) for the separation of magnetic particles of different physical properties, e.g. different susceptibility, size, or mass. The magnetic particles may for example be magnetic nanoparticles or beads of the kind described in literature for a use in a magnetic biosensor. The apparatus comprises the following components:
a) A sample chamber in which the particles can move under some non-magnetic influence. Typical examples of such a non-magnetic influence are electrical forces acting on charged or polarized particles, viscous drag or thermal energy.
b) A magnetic field generator for generating a magnetic actuation field that exerts magnetic actuation forces on the magnetic particles, wherein said magnetic actuation forces affect the motion of particles of different properties differently. The continued motion of the particles under the influence of the magnetic actuation forces will therefore separate particles of different properties on a macroscopic scale.

The apparatus has the advantage that it exploits an interaction between some non-magnetic influence and magnetic actuation forces to generate or change a movement of the magnetic particles that will eventually separate them. By changing the relative strength between non-magnetic and magnetic interactions, the thresholds of the separation process can be adjusted as desired.

In a first preferred embodiment of the invention, the apparatus comprises a transportation device for generating in the sample chamber a flow of a sample fluid containing the magnetic particles. The transportation device may be any kind of device that is capable of inducing the desired flow. It may for example comprise a microfluidic pump or apply capillary forces or electrical actuation of the sample fluid. If the apparatus is also used for other purposes (e.g. the diagnosis of a sample), it will usually already comprise a suitable transportation device for the movement of the sample. The forced flow of the sample fluid will generate a hydrodynamic force (viscous drag) on the magnetic particles which serves as a non-magnetic influence of the kind mentioned above that actively moves the magnetic particles in the sample chamber. The magnitude of this force, and thus the speed of the particle movement, can be adjusted via the transportation device. A further advantage of the transportation device is that it induces a basic, comparatively fast movement of the magnetic particles which can quickly achieve the desired macroscopic separation of different particles, wherein the magnetic force only needs to change some initial parameters of this movement. Thus the magnetic field may for example be used to deflect particles with certain properties from their “normal” course.

In an optional embodiment of the invention, the sample chamber of the apparatus comprises at least one branch for dividing a flowing sample fluid into different fractions comprising different compositions of magnetic particles. A spatial separation of the magnetic particles in a flowing sample can thus be fixed by splitting the flow into a given number of branches that can separately be processed in different sections of the apparatus.

In another variant of an apparatus with a transportation device, the magnetic field generator comprises at least one conductor wire that crosses a region in the sample chamber through which a flow (induced by the transportation device) of a sample fluid can take place, wherein said conductor wire changes its inclination with respect to the local flow direction. The vector component of the viscous drag that is exerted by a fluid flow on a magnetic particle orthogonal to the conductor wire will therefore change accordingly in magnitude. If the operating parameters are suitably adjusted, there will be a point along the conductor wire where said orthogonal component surmounts for a given particle the magnetic force that is generated by a current flowing through the wire. As a consequence, the considered magnetic particle will be torn away from the conductor wire by the fluid flow, wherein the point where this happens depends on the hydrodynamic and most of all magnetic properties of the particle. It should be noted that the fluid flow may be curved with respect to an e.g. straight conductor wire, though it is usually preferred that the conductor wire follows a curved line with respect to a uniform, parallel fluid flow.

In a further development of the aforementioned embodiment, the conductor wire changes its inclination with respect to the local flow direction continuously from parallel to orthogonal. If a uniform parallel sample flow is then directed in such a way that magnetic particles in the fluid first encounter the parallel section of the conductor wire, they will experience a viscous drag orthogonal to the wire that increases along the wire from zero to a maximal value. The magnetic particles will therefore travel along the wire until they are torn away from it at a particle-specific position. This leads to a spatial separation of particles with different physical properties.

In another preferred embodiment of the invention, the non-magnetic influence that can move the magnetic particles in the sample chamber comprises thermal energy of the particle, i.e. a movement under forces conveyed by microscopic collisions between the magnetic particles and particles of the surrounding medium that both move randomly according to their thermal energy. These collisions generate what is known as “Brownian motion” for microscopically visible particles.

In a particular realization of the aforementioned approach, the magnetic field generator is designed in such a way that it can generate a magnetic potential with at least one local minimum, wherein magnetic particles of different properties can escape from that potential by thermal motion with different rates. Thus there is a kind of temporal separation of magnetic particles that are initially trapped at the local minimum of the magnetic potential.

In a particular realization of the aforementioned embodiment, the apparatus comprises a plurality of conductor wires for generating an undulating magnetic potential in the sample chamber above them. Thus the process of a differently fast migration of different magnetic particles is repeated in a series of wells of the magnetic potential.

In another realization of the invention, particularly of the apparatus with at least one local minimum in the magnetic potential, the apparatus further comprises a magnetic source for generating a non-uniform magnetic field throughout the sample chamber in such a way that a transport in a certain direction (of decreasing “uniform potential”) is enhanced. The magnetic source may for example comprise a permanent magnet or a coil.

In a further embodiment the apparatus comprises at least two neighboring conductor wires and an associated control unit for supplying said wires with currents in such a temporal pattern that only a fraction of magnetic particles trapped at one of the conductor wires can escape from there to the other conductor wire. This approach is based on the fact that the velocity of a particle movement in a magnetic actuation field is dependent on particle properties, e.g. on its magnetic susceptibility and viscous drag coefficient with respect to the surrounding medium. Particles that are initially trapped at a first conductor wire will start to move to a neighboring second conductor wire if the current through the first wire is switched off; particles of different properties will then have traveled different distances if after some time the current in the first wire is switched on again. A part of the particles will not have had enough time to come into the sphere of influence of the neighboring current wire and will therefore return to the first wire. The magnetic particles of different properties can thus spatially be separated from each other. Which particles are trapped and which can escape may for example be adjusted by changing the current through the conductor wires, the distance between the wires and/or the temporal pattern of the current supply.

In a further development of the aforementioned embodiment, the apparatus comprises at least two pairs of parallel, neighboring conductor wires which have different distances from each other. When the conductor wires of these pairs are driven with the same currents, they will separate magnetic particles at different thresholds and therefore allow in combination a subdivision of an ensemble of magnetic particles into at least three classes.

In the previous two embodiments, the currents supplied by the control unit may be equal in magnitude. It is however also possible that the control unit supplies currents with different magnitudes to the conductor wires. Then different pairs of conductor wires can have different separation characteristics even if their wires are equally spaced apart.

The apparatus as it was described above may be an autonomous device that is only used for the separation of magnetic particles according to their different properties. Alternatively, the separation capability of the apparatus can also be combined with some other functionality, e.g. if the separation feature is added to some existing device. Thus the apparatus may optionally comprise at least one optical, magnetic, mechanical, acoustic, thermal and/or electrical sensor unit. A microelectronic sensor device with magnetic sensor units is for example described in the WO 2005/010543 A1 and WO 2005/010542 A2 (which are incorporated into the present text by reference). Said device is used as a microfluidic biosensor for the detection of biological molecules labeled with magnetic beads. It is provided with an array of sensor units comprising wires for the generation of a magnetic field and Giant Magneto Resistance devices (GMRs) for the detection of stray fields generated by magnetized beads. Moreover, optical, mechanical, acoustic, and thermal sensor concepts are described in the WO 93/22678, which is incorporated into the present text by reference.

The invention further relates to a method for separating magnetic particles of different properties, for example magnetic susceptibility, particle size, particle mass, mass density, or electrical charge of the particle. The method comprises the following steps:
a) Letting the magnetic particles move in a sample chamber under a non-magnetic influence, wherein the word “letting” shall optionally comprise both active processes (e.g. actively exerting non-magnetic forces on the particles to induce their movement) as well as passive processes (e.g. allowing the always present thermal movement of the magnetic particles). The non-magnetic influence may for example comprise thermal energy, hydrodynamic forces, or electrical forces.
b) Exerting magnetic forces on the magnetic particles, wherein these magnetic forces affect the aforementioned motion of particles with different properties differently.

The method comprises in general form the steps that can be executed with an apparatus of the kind described above. Therefore, reference is made to the preceding description for more information on the details, advantages and improvements of that method.

The invention further relates to the use of an apparatus of the kind described above for molecular diagnostics, biological sample analysis, and/or chemical sample analysis, particularly the detection of small molecules. Molecular diagnostics may for example be accomplished with the help of magnetic beads that are directly or indirectly attached to target molecules.

These and other aspects of the invention will be apparent from and elucidated with reference to the embodiment(s) described hereinafter. These embodiments will be described by way of example with the help of the accompanying drawings in which:

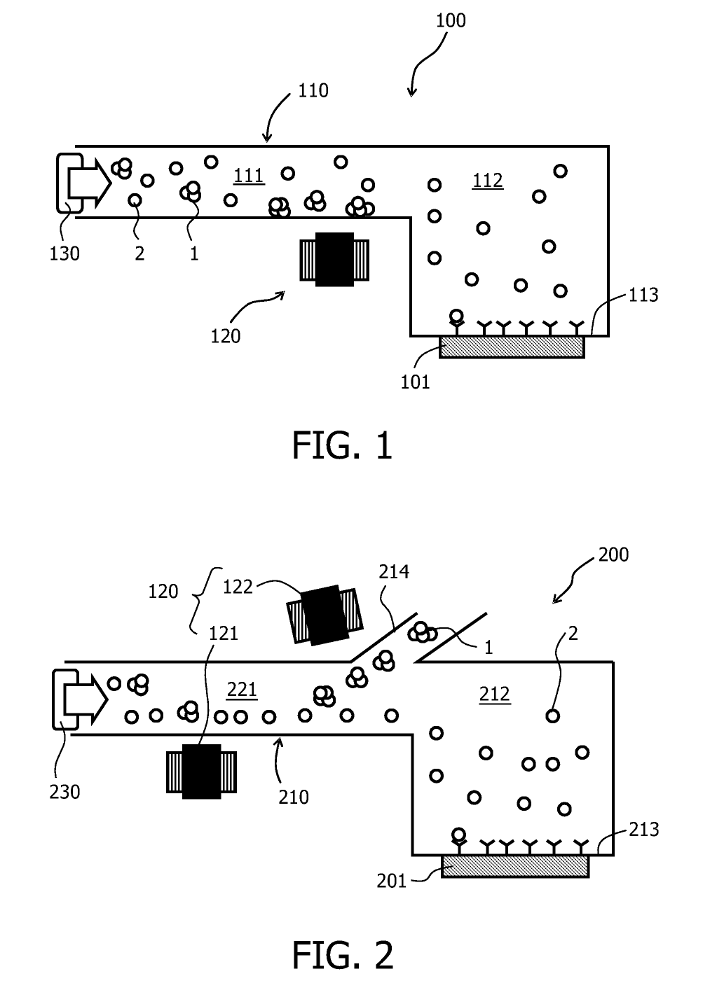

FIG. 1 shows an embodiment of an apparatus for the separation of magnetic particles in which clusters of a these particles are deflected to the bottom of a flow channel;

FIG. 2 shows an embodiment in which clusters of magnetic particles are deflected into a side branch of a flow channel;

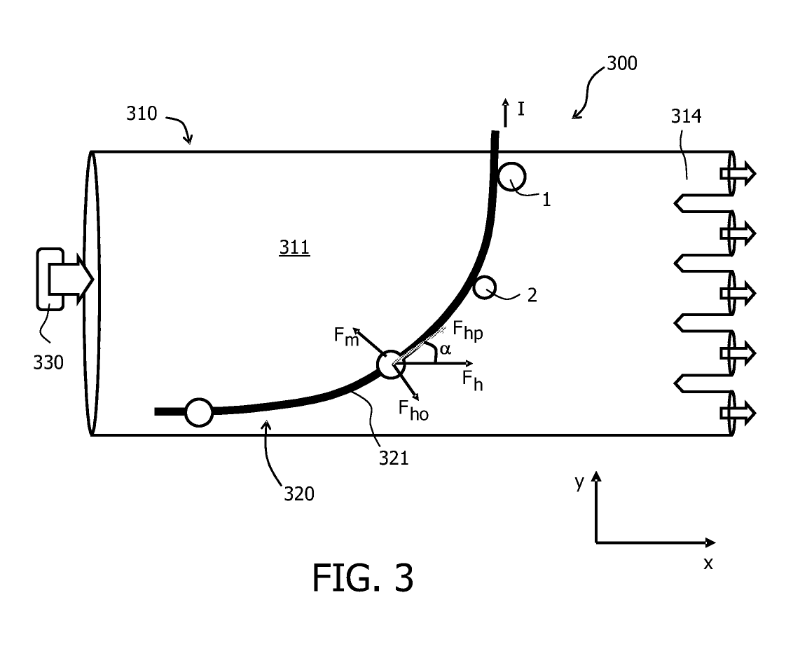

FIG. 3 shows an embodiment in which a curved wire deflects magnetic particles sideward with respect to the flow of a sample fluid;

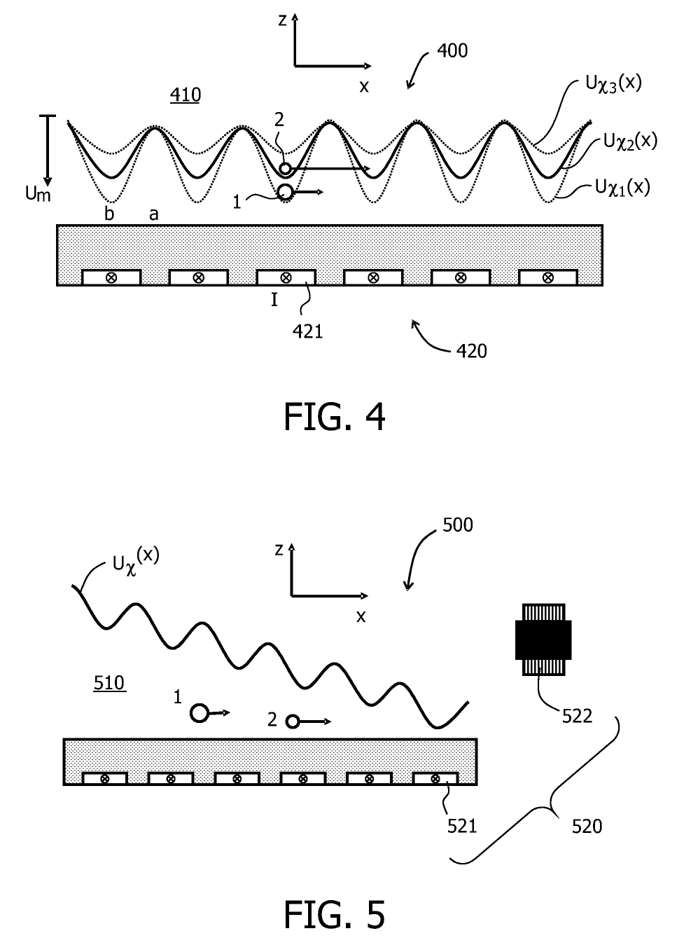

FIG. 4 shows an embodiment in which parallel conductor wires generate an undulating magnetic potential from which magnetic particles escape with different rates;

FIG. 5 shows a variant of the apparatus of FIG. 4 in which an external magnet is used to impose a preferential direction of particle movement;

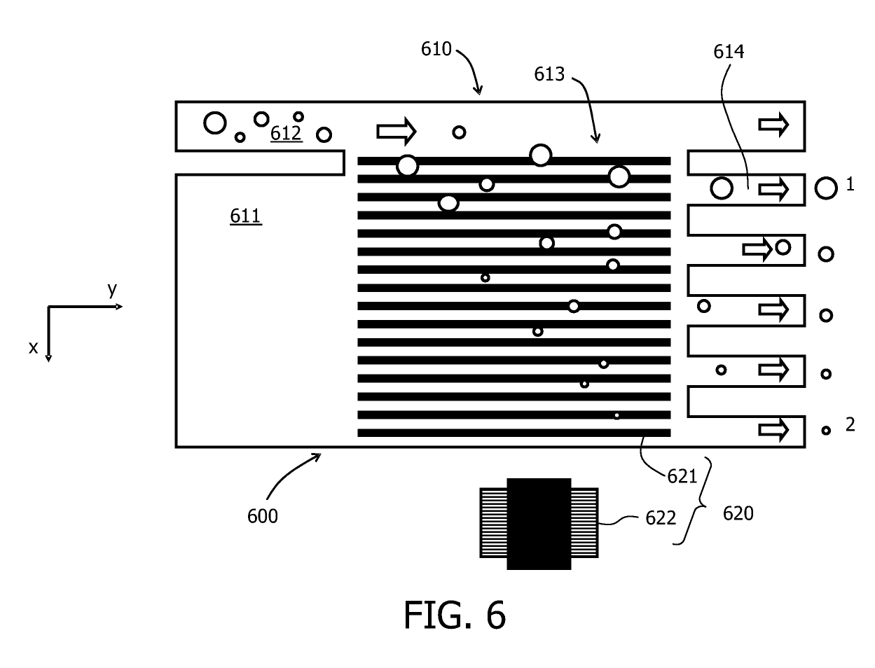

FIG. 6 shows a top view of the apparatus of FIG. 4 integrated into a flow channel;

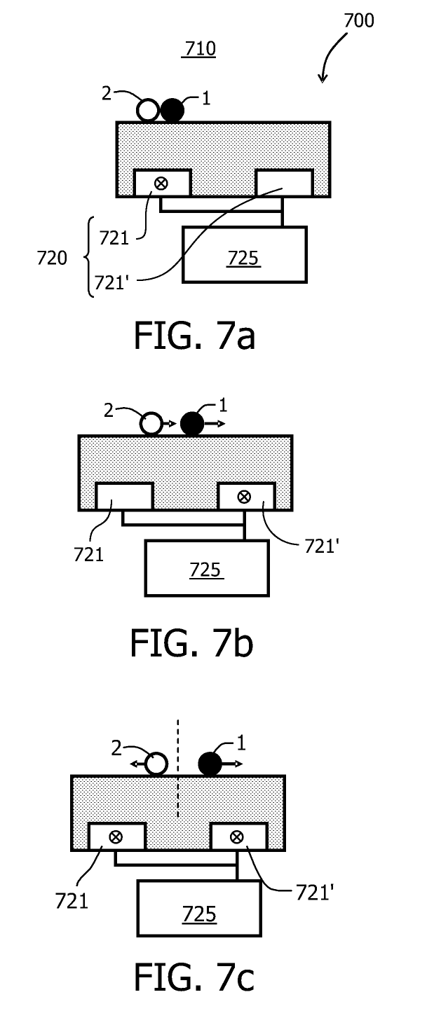

FIG. 7 shows three consecutive stages in an embodiment that applies special temporal activation patterns of parallel conductor wires to pull only a fraction of magnetic particles from one wire to a neighboring one;

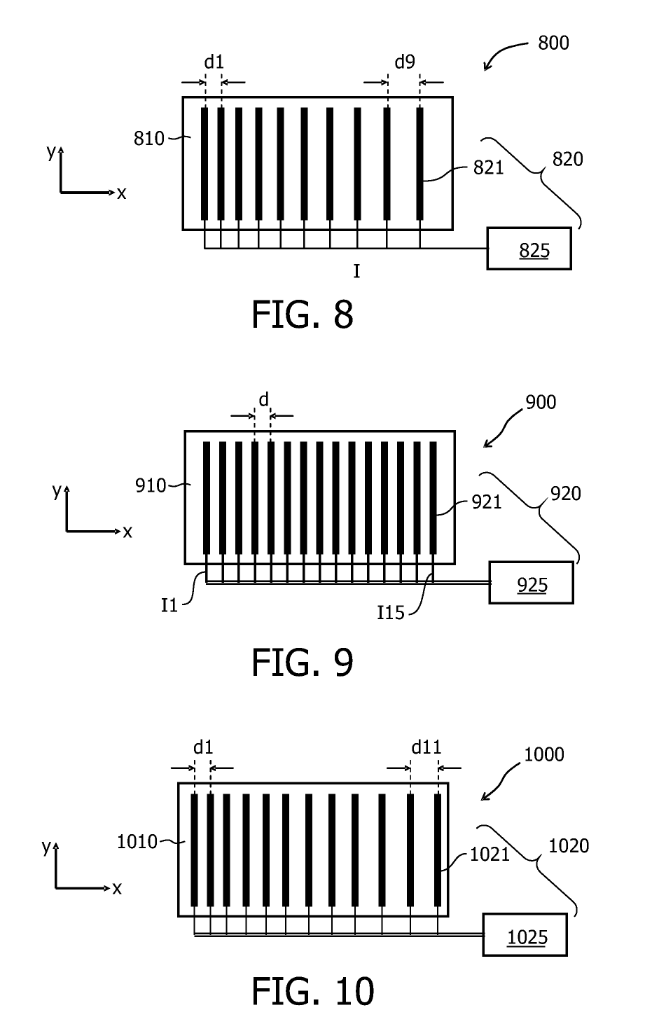

FIG. 8 shows a top view of a variant of the apparatus of FIG. 7 with increasing distances between neighboring conductor wires;

FIG. 9 shows a top view of a variant of the apparatus of FIG. 7 with equal distances between neighboring conductor wires that are supplied with different currents;

FIG. 10 shows a top view of an apparatus that combines the designs of FIGS. 8 and 9;

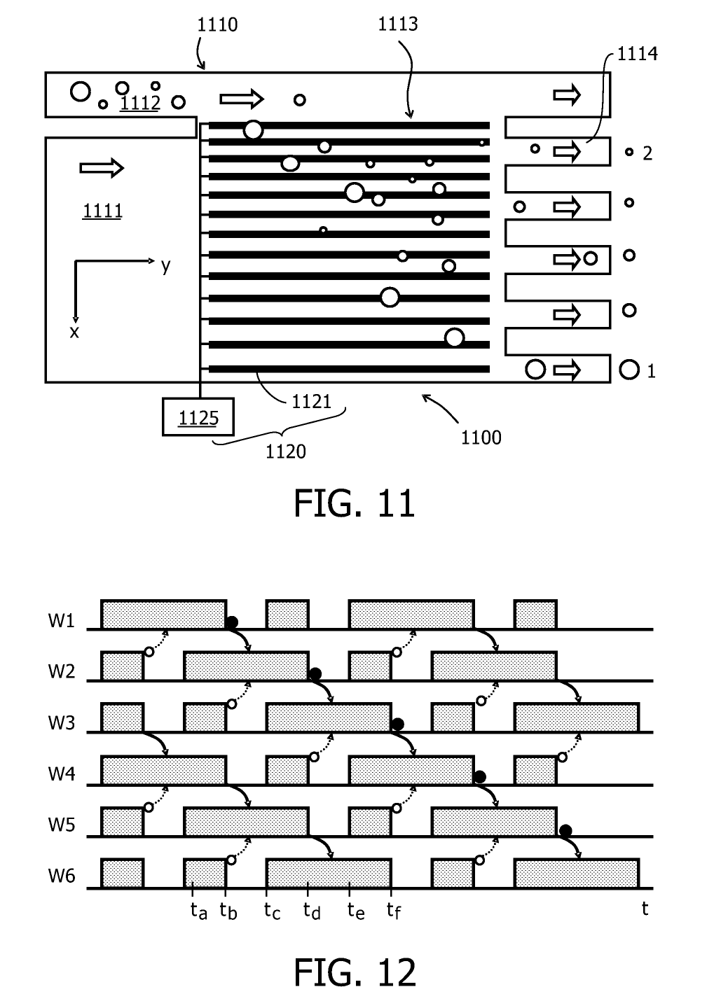

FIG. 11 shows a top view of the apparatus of FIG. 10 integrated into a flow channel;

FIG. 12 illustrates the activation pattern of the conductor wires in an apparatus according to FIGS. 7 to 11.

Like reference numbers or numbers differing by integer multiples of 100 refer in the Figures to identical or similar components.

Magneto-resistive biochips or biosensors have promising properties for bio-molecular diagnostics, in terms of sensitivity, specificity, integration, ease of use, and costs. Examples of such biochips are described in the WO 2003/054566, WO 2003/054523, WO 2005/010542 A2, WO 2005/010543 A1, and WO 2005/038911 A1, which are incorporated into the present application by reference.

The aforementioned magnetic biosensors use magnetic nanoparticles as labels for target molecules to be detected. The smaller these magnetic particles are, the less interference is expected with biological processes. Therefore the use of nanometer-sized superparamagnetic beads with a typical diameter of 200 nm to 300 nm is preferred. When poly-disperse beads are used as labels in a magnetic biosensor, it is impossible to uniquely relate the sensor signal to a number of labels. For the detection as well as for field-assisted transport in a system it is therefore important to have well-characterized particles, which are monodisperse in their magnetic properties, in particular concerning the magnetic susceptibility. Also for other applications such as Magnetic Particle Imaging monodisperse magnetic nanoparticles are desired.

In commercially available batches of magnetic particles the magnetic susceptibility can however vary considerably. This is in large part caused by the distribution in particle diameters, because the magnetic susceptibility depends on the amount of magnetic material inside a particle, and therefore on the volume of the particles. Batches of nanometer-sized superparamagnetic beads often show large size distributions up to a coefficient of variation of 50%. This can lead to differences in the susceptibility of an order of magnitude. Next to the particle volume, also other factors like the shape of the particle, the packing fraction and the microstructure can lead to differences in the magnetic susceptibility. To be able to use the commercially available superparamagnetic beads in a magnetic biosensor, it is necessary to have a device that separates the particles on their magnetic susceptibility.

A related problem of magnetic biosensors arises from the fact that during preparation typically a small fraction of the magnetic beads forms clusters. When such a cluster binds at the sensitive surface, this gives rise to a much higher signal. As a consequence too high a reading is obtained.

In the following, various designs of apparatuses are described that address the above problems.

A first embodiment of a biosensor 100 with magnetic particle separation is shown in FIG. 1. It comprises a sample chamber 110 with a flow channel 111, a reaction chamber 112, a sensitive surface 113 coated with binding sites for target substances, and a sensor unit 101 for the detection of magnetic beads 2 that serve as labels for (bio-) molecules of interest. Moreover, the biosensor comprises some means 130 for generating a flow of a sample fluid through the sample chamber 110.

As already mentioned, the sample does not only contain single beads 2, but also clusters 1 of several beads. The properties of a bead cluster 1 differ from that of a single bead 2 in the following ways:
a bead cluster 1 has larger dimensions and thus mass than a single bead 2;
a bead cluster 1 diffuses more slowly than a single bead 2;
a bead cluster 1 has a higher magnetic susceptibility and therefore a bead cluster is attracted more strongly towards a magnet than a single bead 2.

These properties are used in the biosensor 100 to prevent the clusters 1 from reaching the sensor surface 113. The biosensor 100 comprises to this end a magnetic field generator, e.g. an electromagnet 120, located near the bottom of the flow channel 111, which traps the bead clusters 1 magnetically before they can reach the sensor surface 113. The magnetic force of the magnet 120 is used to pull clustered beads 1 out of the solution and to trap them at the channel wall. Since clusters 1 of beads are attracted more strongly than single beads 2, it is possible to tune the magnetic force in such a way that typically the clusters 1 are trapped while single beads 2 can reach the sensor surface 113. The clusters can also be trapped with gravitational force by allowing them to settle before reaching the sensor surface. The fast diffusing single beads 2 do not settle as quickly and thus can reach the sensor surface. The movement of single particles towards the sensor may be enhanced with a fluidic flow.

In the alternative embodiment of a biosensor 200 shown in FIG. 2, the bead clusters 1 are diverted magnetically into a different branch 214 of the flow channel 211 to prevent them from reaching the sensor surface 213. To this end both the single beads 2 and the bead clusters 1 are first focused to one side of the channel 211. This can be done by magnetic forces generated by a first magnet 121 near said side; it might however also be achieved in other ways, for example using hydrodynamic focusing or using electric fields. After the magnetic particles 1, 2 have been focused, a magnetic force generated by a second magnet 122 pulls the clusters 1 towards the channel branch 214 that does not lead to the sensor surface 213. Since the clusters 1 have stronger magnetic properties than single beads 2, this selection force can be tuned to only divert the clusters, allowing the single beads 2 to reach the sensor surface.

FIG. 3 illustrates the principle of an apparatus 300 that can be used to sort magnetic particles 1, 2 based on their magnetic susceptibility. This allows to obtain a highly mono-disperse sub-population of magnetic particles from a poly-disperse sample. The mono-disperse magnetic particles can then for example be used as labels in a magnetic biosensor.

The apparatus 300 has a sample chamber 310 with a micro-channel 311 through which a suspension of poly-disperse magnetic particles 1, 2 flows, for example by active transportation with a pump 330. The channel 311 is equipped with a magnetic field generator 320 comprising at least one curved conductor wire 321. A control unit (not shown) can supply an electrical current I to said wire 321 which generates a magnetic field gradient that attracts the magnetic particles 1, 2. The particles will thus experience two forces:
a hydrodynamic force Fₕ from the liquid according to Fₕ=6πηrₕv (with η being the viscosity of the fluid, rₕ being the hydrodynamic particle radius, and v being the relative speed of motion of the particle with respect to the liquid), and
a magnetic force Fₘ=χ∇B²/(2μ₀) (with χ being the magnetic susceptibility of the particle, B being the magnetic induction).

At the beginning of the channel 311, the conductor wire 321 is aligned along the direction of flow. The hydrodynamic force Fₕ by the liquid pushes the magnetic particles 1, 2 along the conductor wire 321. The drag force from the liquid on the magnetic particles can be decomposed into a component Fₕₚ along the wire 321 and a component Fₕₒ orthogonal to the wire. The component Fₕₚ along the current line pushes the particles forward, while the orthogonal component Fₕₒ is directed to push the particles away from the conductor. As long as the magnetic force Fₘ is larger than the orthogonal component Fₕₒ of the hydrodynamic force, a particle will continue to move along the conductor.

Because of the curvature of the conductor wire 321, the orthogonal component Fₕₒ of the hydrodynamic force Fₕ increases as a particle moves along the conductor. The apparatus 300 is now assumed to be operated in a regime where at a certain angle α the orthogonal component Fₕₒ of the hydrodynamic force on the particle becomes larger than the magnetic force Fₘ, so that the magnetic particle is pushed off the conductor. Magnetic particles 1 having a higher susceptibility χ will experience a larger magnetic force and therefore these particles 1 will continue to move further along the current line than particles 2 with a lower susceptibility. As a consequence the particles are sorted geometrically as a function of their susceptibility χ. By splitting the channel 311 into a number of smaller channel branches 314, sub-populations of magnetic particles 1, 2 with a narrow distribution in susceptibility can be obtained.

The magnetic particles 1, 2 should enter the sorting section of the channel 311 traveling along the conductor wire 321. This can for example be achieved by hydrodynamic or magnetic focusing of the particles (cf. FIG. 2).

Moreover, the curvature of the conductor wire 321 should be such that the angle α between the conductor and the direction of flow continuously increases; a preferred shape of the conductor is such that the position of the sorted particles along the y-direction correlates linearly with the susceptibility χ of the particle.

It should be noted that strictly speaking the particles are sorted based on a combination of susceptibility and their hydrodynamic drag. Since the magnetic force scales with r³ (when the magnetic density is kept constant) and the drag only scales with r, the separation will be dominated by the susceptibility of the particle. To further increase the mono-dispersity in susceptibility of the sorted particles, the particle can either beforehand or afterwards also be sorted on size.

The embodiments described up to now made use of an interplay between magnetic forces and hydrodynamic forces, i.e. a fluid flow. Particle movement in a resting fluid, on the contrary, might in principle be induced by a magnetic field gradient alone. For nanoparticles the resulting magnetically induced movement would however be disturbed by the Brownian motion of the particles, making very high field gradients necessary to obtain a particle velocity significantly larger than the Brownian motion. This is technologically difficult to achieve. The approach that will be described in the following will on the contrary even exploit the Brownian motion for separation purposes.

FIG. 4 shows a first particular embodiment of such an apparatus 400 that comprises a magnetic field generator 420 with a series of conductor wires 421 embedded in a substrate (e.g. Si) at the bottom of a sample chamber 410. In general, magnetic nanoparticles 1, 2 in a fluid can be trapped in the magnetic potential well that is generated above a microscopic current wire, wherein typical dimensions of such a wire are a width of several microns and a height of a few hundred nanometers. The magnetic potential Uₘ above the wire is dependent on the particle susceptibility χ (unit: m³) and the current I through the wire according to the formula:

$${U}_{m} = χ \frac{{\underline{B}}^{2}}{2 {μ}_{0}} = χ \cdot {I}^{2} ( \frac{{\underline{f} ( x , z )}^{2}}{2 {μ}_{0} {A}^{2}} ) .$$

Here B is the magnetic induction, f(x,z) an analytical function that accounts for the geometry of the system, and A the cross-section of the wire. If multiple parallel wires are placed together, an array of potential wells is created as indicated in FIG. 4 for three potentials Uχ₁, Uχ₂, Uχ₃ for different values of the susceptibility χ₁>χ₂>χ₃.

In the potential wells a magnetic particle 1, 2 can still move due to its thermal energy k_{B}T (with k_{B} being the Boltzmann constant and T the temperature). Whether a particle can cross the barriers in between the potential wells depends on the height of the barrier compared to the thermal energy of the particle. The escape rate k_{esc} from a well is given by the Kramers formula:

$${k}_{ecs} = \frac{1}{6 πη {r}_{h} \cdot 2 π} \sqrt{{U}_{m}^{″} ( a ) \vert {U}_{m}^{″} ( b ) \vert} \cdot exp ( \frac{{U}_{m} ( a ) - {U}_{m} ( b )}{{k}_{B} T} ) ,$$

where a and b are the points of respectively the minimum and maximum potential energy (cf. FIG. 4). The term 6πηrₕ is the drag coefficient of the particle in the fluid, with rₕ being the hydrodynamic radius of the particle and η the viscosity of the fluid.

As is shown in FIG. 4, the magnetic potential wells and barriers are dependent on the particle susceptibility χ. Therefore, a particle 2 with a lower susceptibility χ₂ has a larger chance of crossing the barriers and thus a higher escape rate than a particle 1 with a higher susceptibility χ₁. This can be used to separate the particles on their susceptibility. By changing the current I through the wires 421, the barriers height is changed. Thus it can be selected which susceptibility is allowed to pass easily.

In the configuration of FIG. 4, transport of particles 2 (and, to a less degree, also of particles 1 with higher susceptibility) will occur in random direction. For transport in a fixed direction, an extra magnetic field can be used with a gradient in one direction. This is shown in FIG. 5 for an alternative apparatus 500 in which the magnetic field generator 520 comprises an external magnet 522 additionally to the conductor wires 521. The magnetic field of this magnet 522 causes a slope of the potential U_{χ} in the sample chamber 510 that makes the particles 1, 2 preferably move in positive x-direction.

In FIGS. 4 and 5 it was implicitly assumed that all wires 421, 521 and currents I through these wires are equal. As a consequence, all potential wells are equally steep. The current can then be tuned in such a way that in principal all particles can eventually travel all the way to the end. As however particles with a lower susceptibility will travel across faster than particles with a higher susceptibility, a temporal separation can be achieved.

In an alternative approach (not shown) the potential wells are made increasingly steeper, for example by increasing the currents along the series of the conductor wires 421 or 521. Particles with a certain susceptibility will then at a particular point practically not be able to make the transfer any more. In this approach the particles will be sorted geometrically, when given enough time.

It should be noted that the escape rate in the Brownian motion separation principle of the apparatuses 400 and 500 is influenced both by magnetic properties and by the hydrodynamic radius of the particles. This influence would also exist in a “magnetophoretic” separation process in which only a monotonously varying magnetic field would act on the particles (e.g. only the field of magnet 522 in FIG. 5 if the current I through the wires 521 is zero). Both the Brownian motion escape rate k_{esc} and the “magnetophoretic speed” are proportional to 1/(6πηrₕ). However, the Brownian motion principle, which uses magnetic forces to restrain particles instead of accelerating them, works better in two ways:
Often smaller particles have a smaller susceptibility. A “magnetophoretic separation” would be based on the fact that particles with a smaller susceptibility move slower. However, if the particle radius is smaller, the drag force is also smaller, so the speed becomes larger. This means that the separation effect is sabotaged. In the Brownian motion separation, particles with a smaller susceptibility move faster. A smaller particle radius also means a faster escape rate, so the separation effect is enhanced.
Moreover, the absolute effect of the hydrodynamic radius is much smaller for Brownian motion separation. If the susceptibility is for example increased from χ to n·χ, the Brownian motion escape rate is changed by k_{esc}(n·χ)=(k_{esc}(χ))ⁿ. The “magnetophoretic” speed v is changed by v(n·χ)=n·v(χ). Thus an increase in susceptibility has a much larger effect than a change in hydrodynamic radius for Brownian motion separation than for “magnetophoretic” separation.

The described embodiments 400 and 500 can easily be integrated in a continuous flow device 600 as it is exemplarily shown in FIG. 6. Here, the sample chamber 610 comprises a fluid inlet 611, a particle inlet 612, a separation region 613, and multiple outlets 614. Fluid and magnetic particles are forced in y-direction (from left to right in the Figure) according to the fluid flow imparted by some transportation device (not shown). Simultaneously, the particles drift orthogonally thereto in x-direction in the separation region 613 with a particle-specific speed under the accelerating influence of Brownian motion and of an external magnet 622 and the restraining influence of the current wires 621. Separate fractions of particles 1, 2 will therefore eventually appear at the different outlets 614. The apparatus 600 obviously offers the possibility to efficiently separate large batches of magnetic beads on their magnetic susceptibility.

In summary, the embodiments illustrated in FIGS. 4, 5, and 6 propose a magnetic particle separator based on a principle that exploits the Brownian motion. An array of wires and an optional external magnet are used to separate magnetic nanoparticles on their susceptibility, because a particle with a lower susceptibility has a larger chance of crossing the barriers and thus a higher escape rate than a particle with a higher susceptibility. This separator is particularly suitable for particles smaller than 500 nm and can be integrated in a continuous flow device.

The further separation approach that will be described in the following with reference to FIGS. 7 to 12 can again best be explained in comparison to a “magnetophoretic” particle separation that would let the magnetic particles simply migrate for a certain time in a resting fluid under the influence of a (time-invariant) magnetic field gradient. The speed v of a particle will in this case be directly proportional to its susceptibility χ according to the formula

$$v = \frac{1}{6 πη {r}_{h}} χ \cdot ∇ ( \frac{{\underline{B}}^{2}}{2 {μ}_{0}} ) .$$

Here η is the fluid viscosity, rₕ the hydrodynamic radius of the particles, and B the magnetic induction. The equation shows that particles with a higher susceptibility will obtain a higher speed v in the same magnetic field gradient than particles with a low susceptibility. If this principle is used to separate nanometer-sized particles, the motion will however be disturbed by the Brownian motion of the particles. To obtain a “magnetophoretic” speed significantly larger than the Brownian motion, the following relation should apply over time t:

$$\int \frac{1}{6 πη {r}_{h}} χ \cdot ∇ ( \frac{{\underline{B}}^{2}}{2 {μ}_{0}} ) d t >> 2 \sqrt{\frac{Dt}{π}} , D = \frac{{k}_{b} T}{6 πη {r}_{h}}$$

where D is the diffusion coefficient of the particles, including their thermal energy k_{B}T (with k_{B} being the Boltzmann constant and T the temperature). This relation shows that for nanometer-sized particles high field gradients are needed to obtain a sufficiently high speed. Typical values of ∇B² for 300 nm particles are higher than 1 T²/m. It is technologically difficult to obtain these gradients over large areas. Moreover, for a true separation on susceptibility it is necessary to stay in the low magnetic field region below 10 mT. In this range it is even more difficult to obtain sufficiently high gradients.

In view of these problems, a particle separator 700 suitable for nanometer-sized particles 1, 2 is proposed that is schematically shown for various separation stages in FIG. 7. The apparatus 700 comprises a magnetic field generator 720 with at least two conductor wires 721, 721′ embedded in a substrate under a sample chamber 710 and an associated control unit 725. Typical dimensions of such wires are a width of several microns and a height of a few hundred nanometers. Close to the wires (on the order of tens of micrometers) very high field gradients are obtained, while keeping the field magnitude below 10 mT. If larger fields are desired, external magnets can be added.

The separation in the apparatus 700 is based on the transfer time that magnetic particles 1, 2 need to travel from one wire 721 to a neighboring wire 721′. This transfer time depends on the obtained speed and therefore on the particle susceptibility. In the first stage a) of a separation step shown in FIG. 7, all particles 1, 2 are attracted to a first wire 721 as this is supplied with a current I while the neighboring second wire 721′ is turned off. When the first wire 721 is turned off and the second wire 721′ next to it is turned on in stage b), particles 1, 2 will travel to the second wire 721′. After a certain time, the first wire 721 is turned back on in stage c) while the activity of the second wire 721′ is continued. The particles 1 with a high susceptibility χ have traveled fast enough to come further than half the distance between the wires 721, 721′. These particles 1 will therefore continue traveling to the second wire 721′. The particles 2 with a low susceptibility χ will however travel back to the first wire 721. At the end of this separation step, magnetic particles will therefore spatially be separated according to their susceptibility. By tuning the currents I and the switching frequencies, it can be determined which minimum particle susceptibility is required to make the transfer.

The separation of a batch of magnetic particles in multiple fractions can favorably be performed by using a magnetic field generator with an array of wires and an associated control unit. Three embodiments of such an array are shown in FIGS. 8, 9, and 10.

In FIG. 8, the wires 821 have increasing distances d1, . . . d9 in the x-direction and they are supplied by the control unit 825 with equal currents I.

In FIG. 9, the wires 921 have equal distances d, but they are supplied by the control unit 925 with currents I1, . . . I15 of decreasing magnitude in the x-direction.

In FIG. 10, a combination of the aforementioned designs is realized with groups of neighboring wires 1021, wherein the distances of wires within a group are equal while these “group-distances” d1, . . . d11 increase in the x-direction. All wires are typically supplied with the same current. This embodiment is particularly suited for suppressing the influence of Brownian motion even more than is already achieved by the high field gradients associated to the use microscopic current wires, because a particle has to make several similar transfers over the same distance to continue the process. Thus accidental transfers due to Brownian motion are avoided.

By increasing the distance between the wires and/or by decreasing the current through the wires in x-direction, it is possible to separate magnetic particles into multiple fractions: the particles with the highest susceptibility will be able to make all the transfers in x-direction, the particles with the lowest susceptibility will stay at the beginning, and all particles with intermediate susceptibilities will end somewhere in between.

The described embodiments 700 to 1000 can easily be integrated in a continuous flow device 1100 as it is exemplarily shown in FIG. 11. Here, the sample chamber 1110 comprises a fluid inlet 1111, a particle inlet 1112, a separation region 1113, and multiple outlets 1114. While fluid and magnetic particles are forced in y-direction (from left to right in the Figure) according to the fluid flow imparted by some transportation device (not shown), the particles simultaneously drift orthogonally thereto in x-direction in the separation region 1113 under the time-varying attraction of the current wires 1121 with a particle-specific speed. Separate fractions of particles 1, 2 will therefore eventually appear at the different outlets 1114. The apparatus 1100 obviously offers the possibility to efficiently separate large batches of magnetic beads on their magnetic susceptibility.

If an array of wires is used as shown in FIGS. 8 to 11, it is necessary to actuate the wires in a particular temporal pattern in order to prevent mutual disturbances of their effects. FIG. 12 illustrates such an activation pattern for six wires W1, . . . W6 that are activated in three groups (i.e. the pattern could readily be extended to further wires), wherein transitions of particles (with the “right”—i.e. high enough—susceptibility) are indicated by arrows. If a particle has for example to travel from wire W2 to wire W3, there is no current allowed in wire W1, otherwise the particle would have a possibility to travel back. In more detail, particles 1 with a susceptibility that is high enough for a transfer pass through the following stages at sequential times t:
tₐ: wire W1 on, particles attracted to wire W1;
t_{b}: wire W1 off, wire W2 on: particles start moving to wire W2;
t_{c}: wire W1 back on, wire W2 still on: particles 1 that are closer to wire W2 will continue moving to wire W2, particles that are closer to wire W1 will go back to wire W1;
t_{d}: wire W2 off, wire W3 on: particles start moving to wire W3; to prevent particles from moving back to wire W1, wire W1 is also off;
tₑ: wire W2 back on, wire W3 still on: particles 1 that are closer to wire W3 will continue moving to wire W3, particles that are closer to wire W2 will go back to wire W2;
t_{f}: wire W3 off, wire W4 on: particles start moving to wire W4; to prevent particles from moving back to wire W2, wire W2 is also off;
etc.

It should be noted that there are combinations of wire-activities in which a particle 2 of low susceptibility could move in backward direction (indicated by dotted arrows in FIG. 12). The proposed activation pattern guarantees, however, that the particles 1 are already at the next wire in forward direction when such a condition occurs. Thus the particles 1 will effectively be transported in one direction only.

In summary, the described magnetic particle separators 700 to 1100 are based on an array of microscopic current wires which allow to obtain high field gradients (>1 T²/m), suitable for separation of nanometer-sized particles while maintaining a low total field magnitude (<10 mT). The set-up can be refined to minimize the influence of Brownian motion and can be integrated in a continuous flow device, offering the possibility to efficiently separate large batches on the magnetic susceptibility.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An apparatus (100-1100) for separating magnetic particles (1, 2) of different properties, comprising
a) a sample chamber (110-1110) in which the particles can move under a non-magnetic influence (Fₕ),
b) a magnetic field generator (120-1120) for exerting a magnetic actuation force on the particles (1, 2) that affects the motion of particles with different properties differently.

2. The apparatus (100-1100) according to claim 1,
characterized in that it comprises a transportation device (130-230) for generating in the sample chamber (110-1110) a flow of a sample fluid containing the magnetic particles (1, 2).

3. The apparatus (100-1100) according to claim 1,
characterized in that the sample chamber (110-1110) comprises at least one branch (214, 314, 514, 1114) for dividing a flowing sample fluid into different fractions comprising different compositions of magnetic particles (1, 2).

4. The apparatus (100-1100) according to claim 1,
characterized in that the magnetic field generator (320) comprises a conductor wire (321) that crosses the flow region (311) of a sample fluid in the sample chamber (310) with changing inclination (α) with respect to the local flow direction.

5. The apparatus (100-1100) according to claim 4,
characterized in that the conductor wire (321) changes its inclination (α) continuously from parallel to orthogonal.

6. The apparatus (100-1100) according to claim 1,
characterized in that the non-magnetic influence comprises thermal energy.

7. The apparatus (100-1100) according to claim 1,
characterized in that the magnetic field generator (420-620) generates a magnetic potential (Uχ) with at least one local minimum (b) from which magnetic particles (1, 2) of different properties can escape by thermal motion with different rates.

8. The apparatus (100-1100) according to claim 7,
characterized in that it comprises a plurality of conductor wires (421-621) generating an undulating magnetic potential (Uχ) in the sample chamber (410-610).

9. The apparatus (100-1100) according to claim 1,
characterized in that it comprises a magnetic source (522, 622) for generating a substantially non-uniform magnetic field throughout the sample chamber (520, 620).

10. The apparatus (100-1100) according to claim 1,
characterized in that it comprises at least two neighboring conductor wires (721, 721′, 821-1121) and an associated control unit (725-1125) for supplying said wires with currents in such a temporal pattern that only a fraction of magnetic particles (1, 2) trapped at one of the conductor wires (721) can escape from there to the other conductor wire (721′).

11. The apparatus (100-1100) according to claim 10,
characterized in that it comprises at least two pairs of parallel, neighboring conductor wires (821, 1021) with different distances (d1, d9, d11) from each other.

12. The apparatus (100-1100) according to claim 10, characterized in that the control unit (925, 1025) is adapted to provide different conductor wires (921, 1021) with currents (I1, I15) of different magnitude.

13. The apparatus (100-1100) according to claim 1,
characterized in that it comprises an optical, magnetic, mechanical, acoustic, thermal or electrical sensor unit (101, 201) for detecting properties of a sample in the sample chamber (110-1110).

14. A method for separating magnetic particles (1, 2) of different properties, comprising the steps of
a) letting the magnetic particles (1, 2) move in a sample chamber (110-1110) under a non-magnetic influence (Fₕ);
b) exerting magnetic forces on the magnetic particles (1, 2) which affect the motion of particles (1, 2) with different properties differently.

15. The method according to claim 14,
characterized in that the non-magnetic influence comprises thermal energy, hydrodynamic forces (Fₕ), or electrical forces.

16. The method according to claim 14,
characterized in that the different properties of the particles (1, 2) comprise magnetic susceptibility, size, mass, mass density, or electrical charge.

17. Use of the magnetic sensor device according to claim 1 for molecular diagnostics, biological sample analysis, and/or chemical sample analysis, particularly the detection of small molecules.
